(19) United States
(12) Patent Application Publication
(10) Pub. No.: US 2013/0053097 A1
(43) Pub. Date: Feb. 28, 2013

(54) SMARTPHONE ACCESSORY

(71) Applicant: Christopher Dale Phillips, Land O' Lakes, FL (US)

(72) Inventor: Christopher Dale Phillips, Land O' Lakes, FL (US)

(21) Appl. No.: 13/217,814

(22) Filed: Aug. 25, 2011

(51) Int. Cl. G06F 3/041; H04N 5/225

(52) U.S. Cl. 455/556.1; 455/566

(57) ABSTRACT

An accessory enhances the utility of a smartphone when the accessory is in circuit communication with the smartphone. The accessory includes a touch screen that has a viewable surface area that is larger than a viewable surface area of a touch screen of the smartphone and displays the same image as the touch screen of the smartphone. Signals generated by pressure on the touch screen of the device are conducted to a processor of the smartphone that processes signals generated by pressure of the touch screen of the smartphone. The device may include an audio speaker that projects the same sounds as an audio speaker of the smartphone. The device may include a microphone that generates signals conducted to a component of the smartphone that processes signals generated by a microphone of the smartphone. The device may further include a camera that generates signals conducted to a component of the smartphone that processes signals generated by a camera of the smartphone. The device is not provided with a memory device for storing programs and applications or a processor for processing programs and applications because it relies entirely upon the programs and applications stored in the smartphone and the processing capabilities of the smartphone for processing the applications and programs.

### FIELD OF THE INVENTION

The present invention relates to an accessory that may be used with a smartphone to enhance the usefulness of some applications of the smartphone.

### BACKGROUND OF THE INVENTION

Smartphones and tablet personal computers are currently marketed as separate products, and many persons find it desirable to obtain one of each. However there are many applications that are duplicated by the two devices. The size of the touch screen of a smartphone may be seen as a disadvantage for certain applications of a smartphone, such as playing complex games or viewing videos. For such applications a tablet personal computer having a significantly larger touch screen than a smartphone is preferred by some persons.

### SUMMARY OF THE INVENTION

There is provided in accordance with the present invention a device that is an accessory for enhancing the utility of a smartphone when the device is in circuit communication with the smartphone. The device includes a touch screen that has a viewable surface area that is larger than a viewable surface area of a touch screen of the smartphone and displays the same image as the touch screen of the smartphone when the device is in circuit communication with the smartphone. When the device is in circuit communication with the smartphone signals generated by pressure on the touch screen of the device are conducted to a processor of the smartphone that processes signals generated by pressure on the touch screen of the smartphone. The device may further include an audio speaker that projects the same sounds as an audio speaker of the smartphone when the device is in circuit communication with the smartphone. The device may further include a microphone that when the device is in circuit communication with the smartphone generates signals conducted to a component of the smartphone that processes signals generated by a microphone of the smartphone. The device may further include a camera that when the device is in circuit communication with the smartphone generates signals conducted to a component of the smartphone that processes signals generated by a camera of the smartphone. The device is not provided with a memory device for storing programs and applications or a processor for processing programs and applications because it relies entirely upon the programs and applications stored in the smartphone and the processing capabilities of the smartphone for processing the applications and programs.

### BRIEF DESCRIPTION OF THE DRAWINGS

FIG. 1 is a front perspective view of a prior art smartphone.

FIG. 1A is a rear perspective view of the prior art smartphone.

FIG. 2 is a perspective view of a tablet personal computer.

FIG. 3 is a perspective view of the front of a device that is a smartphone accessory in circuit communication with a compatible smartphone via a cable.

FIG. 3A is a rear perspective view of the compatible smartphone.

FIG. 4 is a perspective view of the back of another device that is a smartphone accessory in circuit communication with a compatible smartphone via a cable.

FIG. 5 is a perspective view of the back of yet another device that is a smartphone accessory in circuit communication with a compatible smartphone via a cable.

### DETAILED DESCRIPTION OF THE INVENTION

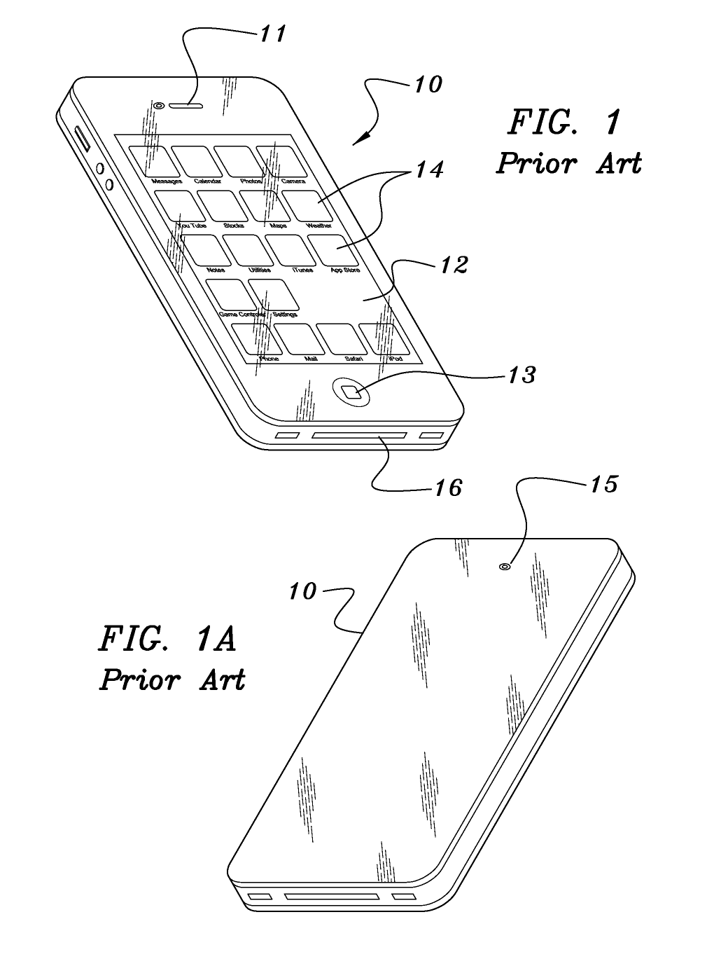

FIG. 1 shows a prior art smartphone 10. The term smartphone is a generic term for a small, all-in-one device that is used for communication and computing functions. Smartphones are marketed using a number of trademarks including IPHONE®. In contrast to an ordinary cell phone a smartphone allows a user to choose the applications that he wants to install and use. A smartphone user can personalize the range of applications in his smartphone to suit his lifestyle and job. Applications for smartphones include for example office suites, games and internet access to movies and music. The smartphone of FIG. 1 is equipped with a touch screen 12. As used herein and in the claims the term “touch screen” is understood to refer to a display screen that can detect and respond to a user selecting options by exerting a force, or pressure, on the screen. The touch screen 12 displays icons 14 that merely have to be touched to activate various functions of the smartphone and various applications that have been stored in the memory of the smartphone. In addition to functioning as a cell phone a smartphone may be connected to the internet using the touch screen 12 as a primary input device and having a wireless adapter for internet and local network connection, and may have Bluetooth capability. A port 16 for receiving a complementary plug attached to a cable is used for charging a battery that powers the smartphone and may also be used for interfacing with another electronic device. The smartphone is provided with an audio speaker 11 and a microphone 13. A typical smartphone is also provided with a camera 15. It is understood that as used herein and in the claims the term “camera” identifies a device that can record both static and moving images. A smartphone includes at least one electronic circuit, also referred to herein and in the claims as electronic circuitry, that communicates with the various operative components of the smartphone. The electronic circuitry includes at least: a processor that processes signals generated by pressure on the touch screen of the smartphone; a processor for processing and amplifying signals intended for the audio speaker; a processor that processes signals generated by the microphone; a component of the smartphone that processes signals generated by the camera and stores images. A smartphone includes a memory device for storing programs, applications and data, as well as a processor for processing data.

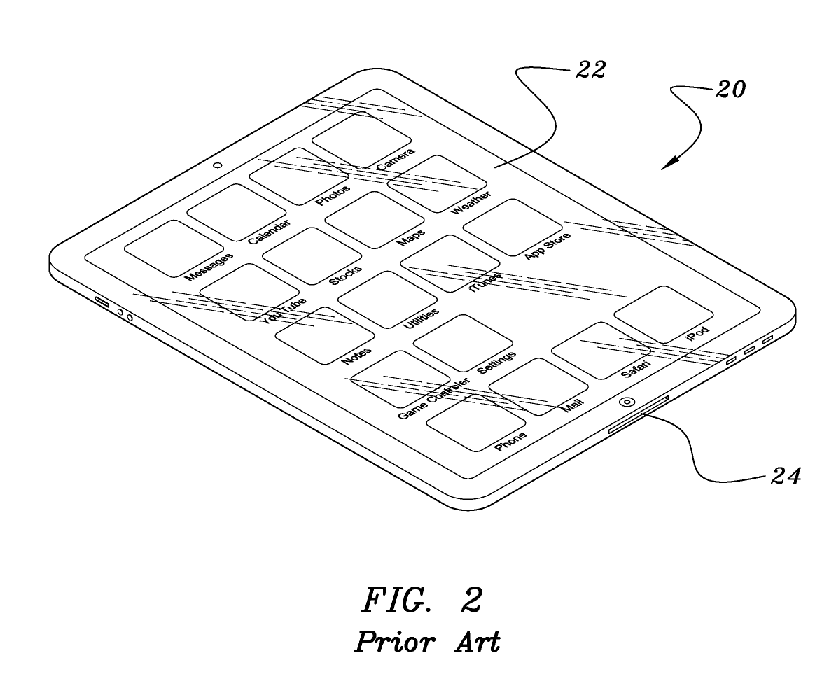

FIG. 2 shows a prior art tablet personal computer 20. The term tablet personal computer is a generic term for a portable electronic machine equipped with a touch screen 22 as a primary input device and having a wireless adapter for internet and local network connection. Tablet personal computers are marketed using a number of trademarks including IPAD®. Software applications for tablet PCs include office suites, games and a variety of applications. A port 24 for receiving a complementary plug attached to a cable is used for providing power to the tablet personal computer and charging a battery that can alternatively power the tablet personal computer. The cable may also be used for interfacing with another electronic device. A tablet personal computer is provided with a memory device for storing programs and data, as well as a processor for processing data.

Prices of tablet personal computers and smartphones range from about US $200.00 to US $600.00. Additional expenses related to a tablet personal computer or smartphone include licenses for copies of programs, sometimes called applications or “apps”, and fees paid to an internet service provider. A popular feature of tablet personal computers is the size of the touch screen, which is considerably larger than the touch screen of a smartphone. Up to date smartphones have large amounts of memory for storing programs and data, and very powerful data processing devices that can adequately run many of the programs that are widely used with tablet personal computers. It would be advantageous if a user of a smartphone could, for example, play complex games and view videos on a larger screen without the expense of obtaining a tablet personal computer for such purposes. This need is addressed by the present invention.

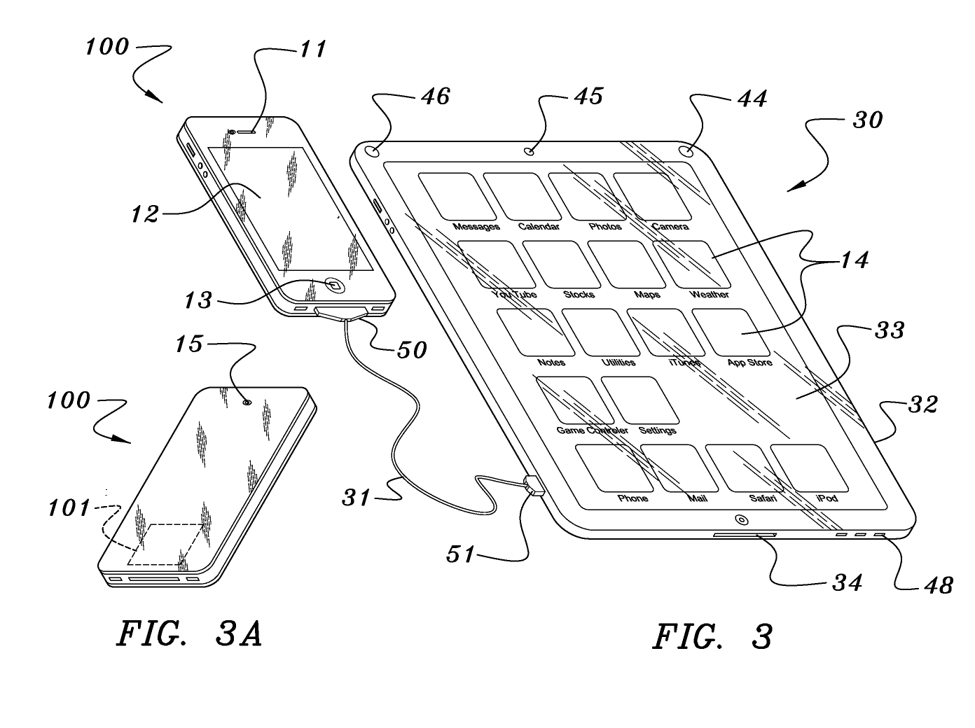

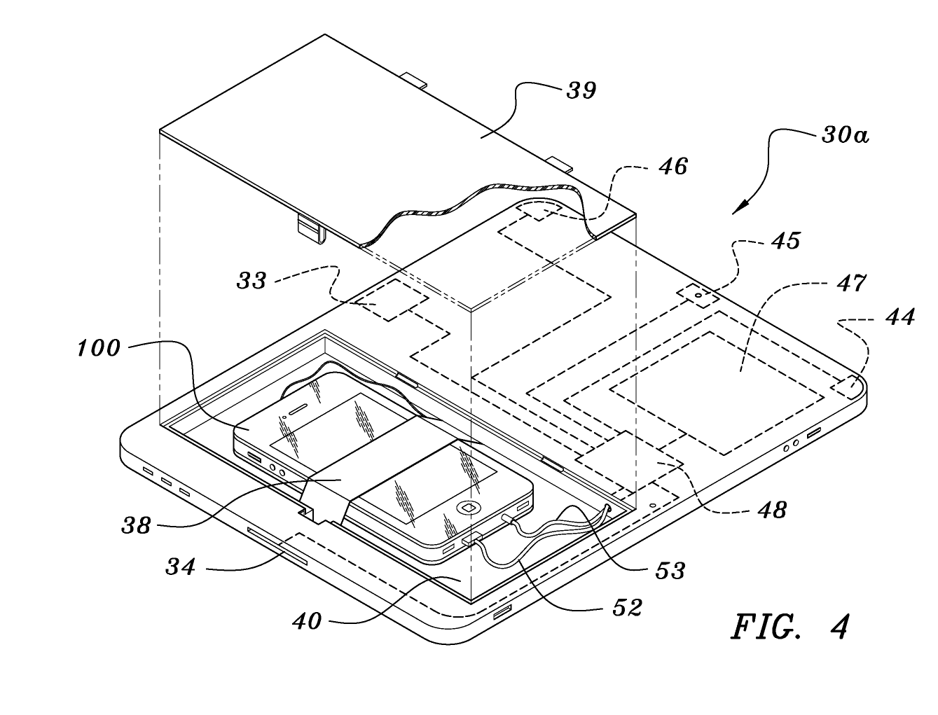

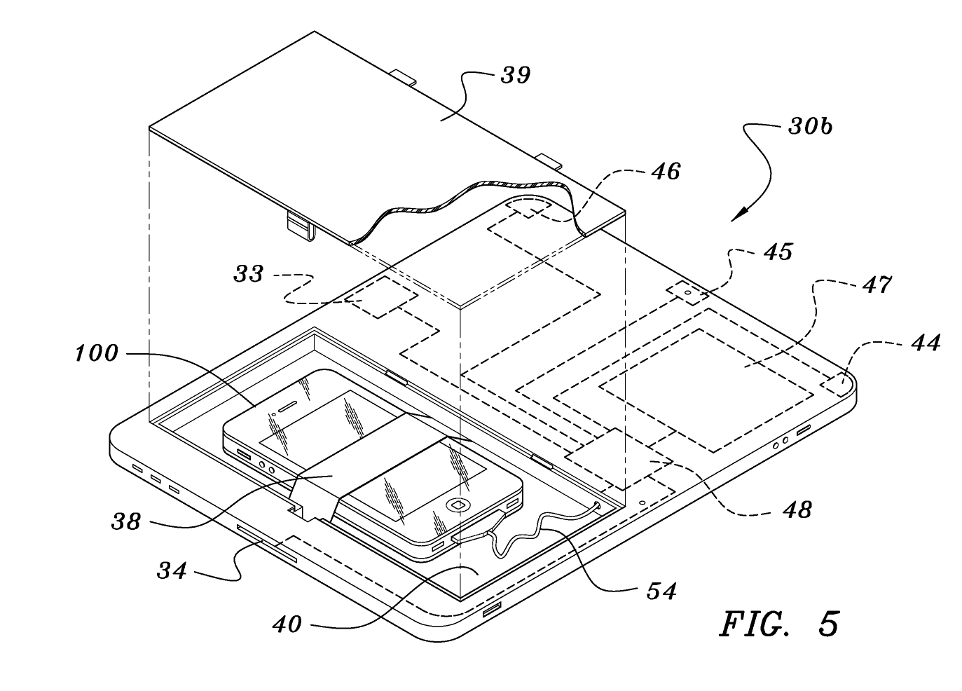

FIG. 3 is a perspective view of a device 30 that is a smartphone accessory in circuit communication with a smartphone 100 via a cable 31. As used herein and in the claims the terms “device” and “accessory” are used interchangeably and both terms are understood to refer to a smartphone accessory as disclosed herein. The device has a port 34 for receiving a complementary plug attached to a cable used for providing power to the device and charging a battery that can alternatively power the device. The device is provided with a structure 32 that gives shape to the device and supports at least one component of the device. The structure 32 may be formed, for example, of plastic or sheet metal. The device is provided with a touch screen 33 that is supported by the structure 32 of the accessory 30. The device 30 may be provided with an audio speaker 44 that is supported by the structure of the device. The device 30 may be provided with a microphone 46 that is supported by the structure of the device. The device 30 may be provided with a camera 45 that is supported by the structure of the device. The device 30 is provided with an electronic circuit, represented schematically in FIGS. 4 and 5, that is in circuit communication with the touch screen, audio speaker, microphone and camera of the device. The electronic circuit of the device may further include a device for storing energy 47, such as a rechargable battery, that can be used to power the device when the device is not connected to an external source of energy via a port 34. It is to be understood that the arrangement of the various components of the device may be customized by a designer or engineer to accommodate the tastes of the designer or engineer and the convenience of the end user of the device.

A smartphone 100 that is compatible with the device 30 that is a smartphone accessory is substantially the same as any other smartphone with one important distinction. As shown in FIG. 3A, which is a rear perspective view of the smartphone 100 that is compatible with the device 30, an electronic circuit of the smartphone 100 is provided with a component 101 that recognizes when an electronic circuit of the device 30 is in circuit communication with the electronic circuit of the smartphone and facilitates conduction of signals between the electronic circuit of the device and the electronic circuit of the smartphone. Circuit communication between an electronic circuit of a device that is an accessory for a smartphone and an electronic circuit of a smartphone can be established by any suitable means selected in accordance with good engineering practices. For example in FIG. 3 a cable 31 with plugs 50, 51 at each end of the cable that mate with compatible ports of the smartphone 100 and device 30 is used to establish circuit communication between the smartphone and the device. Put another way, in this example the smartphone is merely plugged into the accessory. If desired the structure of a device 30a, 30b may include a space 40 for receiving a smartphone 100 as shown in FIGS. 4 and 5. In FIG. 4 two hardwired cables 52, 53 of the accessory have plugs that mate with compatible ports of the smartphone. Two cables could be used in an instance where one cable carries signals from the smartphone to the accessory and one cable carries signals from the accessory to the smartphone, or if one cable carries signals both ways between the smartphone and the accessory and the other cable provides auxiliary power to the smartphone via the electronic circuitry of the accessory. The port of the smartphone that is normally employed for charging the battery of the smartphone may receive a complementary plug attached to a cable that allows energy stored in a battery of the device to transmit energy to the battery of the smartphone to charge the battery of the smartphone and extend the time that the smartphone can be used with the smartphone accessory.

In FIG. 5 one hardwired cable 54 of the accessory has a plug that mates with a compatible port of the smartphone to carry signals both ways between the smartphone and the accessory and may even provide auxiliary power to the smartphone via the electronic circuitry of the accessory.

The electronic circuit of a device that is a smartphone accessory includes a component 48 that directs power to the touchscreen, microphone, audio speaker and camera of the device, and also directs signals to and from the electronic circuit of the smartphone and the electronic circuit of the device. When the device is assembled with a smartphone such that the electronic circuit of the accessory is mated to the smartphone via a cable that communicates with an electronic circuit of the smartphone and the electronic circuit of the accessory thereby establishing circuit communication is thereby established between the smartphone and the device. When the component 101 of the smartphone senses that the smartphone is in circuit communication with the accessory, signals residing in the smartphone that are normally intended for conduction to and from the touch screen of the smartphone are redirected by the component 101 of the smartphone to the electronic circuit of the accessory. The touch screen 33 of the accessory has a viewable surface area that is larger than a viewable surface area of a touch screen 12 of the associated smartphone 100. When the device is in circuit communication with the smartphone images 14 that would otherwise be displayed on the touch screen 12 of the smartphone are instead displayed on the touch screen 33 of the device 30. When the device is in circuit communication with the smartphone the signals generated by pressure on the touch screen of the device are conducted to the same processor of the smartphone that processes signals generated by pressure on the touch screen of the smartphone. The processing of signals to and from the touchscreen of the accessory is done by the electronic circuitry of the smartphone, including cell phone and wireless internet signals. The accessory does not have the capability of doing such signal processing. In effect one function of the device is providing an auxiliary touch screen for a smartphone.

When the device is in circuit communication with the smartphone signals intended for conduction to the audio speaker 11 of the smartphone 100 are instead directed to the audio speaker 44 of the device 30. When the device is in circuit communication with the smartphone signals from the microphone 46 and camera 45 of the smartphone accessory are directed to the smartphone for processing. The accessory does not have the capability of doing such signal processing.

A device that is a smartphone accessory of the present invention is not provided with a memory device for storing programs and applications or a processor for processing programs and applications because it relies entirely upon the programs and applications stored in the smartphone and the processing capabilities of the smartphone for processing the applications and programs. Inasmuch as the programming is not copied to a storage medium in the smartphone accessory device there should not be a need for an additional license fee for programming, as there is in the case of a person using a separate prior art smartphone and a prior art tablet personal computer. Also, there is not a need for an additional internet service provider contract.

Referring again to FIGS. 4 and 5 in these embodiments of a smart phone accessory a cover 39 is displaced to reveal a compartment 40 for receiving a smartphone 100. The smartphone is secured in the compartment by a suitable securing device such as a strap 38 that is held in place by a hook and loop system. The smartphone is temporarily placed in the compartment and a cable 54, or cables 52, 53, provides an interface between the smartphone and a smartphone accessory. Securing the smartphone to the smartphone accessory in this manner enhances the portability of the accessory when it is use.

There are numerous uses for the smart phone accessory. The larger touch screen enhances the playing of games, viewing both still and moving images, and sharing the view on a touch screen with other persons. Video conferencing including real time motion videos using utilities such as Skype™ can be used in conjunction with the microphone, camera and audio speaker of the accessory while the smartphone provides processing of signals and cell phone and wireless internet access. Virtually anything that can be done with a smartphone can be done using the smartphone accessory. A smartphone user can have the best of both worlds, great mobility when desired and needed along with a larger touch screen when mobility is not an issue and it is desired to avoid long periods of staring at a small touch screen.

Many persons may acquire a smartphone that provides easy portability in a pocket or purse, and also a tablet personal computer for uses other than as a telephone. This is a relatively costly situation since there may duplicate programming requiring extra license fees and two internet service provider contracts. This situation may be improved with the device of the present invention which is an accessory for a smartphone that provides a primary advantage of a tablet personal computer which is the larger touch screen. Inasmuch as the programming is not copied to a storage medium in the accessory device there should not be a need for an additional license fee for programming, as there is in the case of prior art tablet personal computers. Also, there is not a need for an additional internet service provider contract.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense. It is also to be understood that the following claims are intended to cover all of the generic and specific features of the invention herein described, and all statements of the scope of the invention which, as a matter of language, might be said to fall there between.

What is claimed is:

1. A device that is an accessory for enhancing the utility of a smartphone when the device is in circuit communication with the smartphone comprising:
(a) a touch screen that displays an image intended for display on a touch screen of the smartphone when the device is in circuit communication with the smartphone and the touch screen of the device generates signals in response to a pressure placed thereon, wherein when the device is in circuit communication with the smartphone the signals generated by pressure on the touch screen of the device are conducted to a processor of the smartphone that processes signals generated by pressure on the touch screen of the smartphone; and
(b) an audio speaker that projects the same sounds as an audio speaker of the smartphone when the device is in circuit communication with the smartphone.

2. The device of claim 1 further comprising a microphone that when the device is in circuit communication with the smartphone generates signals conducted to a component of the smartphone that processes signals generated by a microphone of the smartphone.

3. The device of claim 1 further comprising a camera that when the device is in circuit communication with the smartphone generates signals conducted to a component of the smartphone that processes signals generated by a camera of the smartphone.

4. The device of claim 1 wherein the device includes an electronic circuit that is in circuit communication with the touch screen and audio speaker of the device, and when the electronic circuit of the device is in circuit communication with an electronic circuit of a smartphone and the smartphone includes a component that recognizes when the electronic circuit of the device is in circuit communication with the electronic circuit of the smartphone signals are conducted between the electronic circuit of the device and the electronic circuit of the smartphone.

5. The device of claim 2 wherein the device includes an electronic circuit that is in circuit communication with the touch screen and audio speaker of the device, and when the electronic circuit of the device is in circuit communication with an electronic circuit of a smartphone and the smartphone includes a component that recognizes when the electronic circuit of the device is in circuit communication with the electronic circuit of the smartphone signals are conducted between the electronic circuit of the device and the electronic circuit of the smartphone.

6. The device of claim 3 wherein the device includes an electronic circuit that is in circuit communication with the touch screen and audio speaker of the device, and when the electronic circuit of the device is in circuit communication with an electronic circuit of a smartphone and the smartphone includes a component that recognizes when the electronic circuit of the device is in circuit communication with the electronic circuit of the smartphone signals are conducted between the electronic circuit of the device and the electronic circuit of the smartphone.

7. An accessory for a smartphone comprising:
(a) a structure that gives shape to the accessory and supports at least one component of the accessory;
(b) a touch screen that is supported by the structure of the accessory wherein a signal generated by pressure on the touch screen of the accessory is conducted by an electronic circuit to the smartphone when the accessory and the smartphone are in circuit communication with one another; and
(c) an electronic circuit for conducting from a smartphone to the touch screen of the accessory a signal intended for conduction to a touch screen of the smartphone when the accessory and the smartphone are in circuit communication with one another.

8. The accessory for a smartphone of claim 7 further comprising an audio speaker that is supported by the structure of the accessory, wherein the electronic circuit conducts from the smartphone to the audio speaker of the accessory a signal intended for conduction to an audio speaker of the smartphone when the accessory and the smartphone are in circuit communication with one another.

9. The accessory for a smartphone of claim 7 further comprising a microphone that is supported by the structure of the accessory and is in circuit communication with the electronic circuit, wherein the electronic circuit receives signals from the microphone of the accessory and conducts the signals from the microphone of the accessory to the smartphone when the accessory and the smartphone are in circuit communication with one another.

10. The accessory for a smartphone of claim 7 further comprising a camera that is supported by the structure of the accessory and is in circuit communication with the electronic circuit, wherein the electronic circuit receives signals from the camera of the accessory and conducts the signals from the camera of the accessory to the smartphone when the accessory and the smartphone are in circuit communication with one another.

11. The accessory for a smartphone of claim 7 wherein the structure of the accessory includes a space for receiving a smartphone.

12. The accessory for a smartphone of claim 7 assembled with a smartphone wherein the electronic circuit of the accessory is mated to the smartphone via a cable that communicates with an electronic circuit of the smartphone and the electronic circuit of the accessory thereby establishing circuit communication between the smartphone and the accessory.

13. The accessory for a smartphone of claim 12 wherein the electronic circuit of the smartphone includes a component that recognizes when the electronic circuit of the accessory is in circuit communication with the electronic circuit of the smartphone and facilitates communication between the accessory and the smartphone.

14. An accessory for a smartphone comprising:
(a) a structure that gives shape to the accessory and supports at least one component of the accessory;
(b) a touch screen that is supported by the structure of the accessory that generates a signal in response to a pressure placed thereon;
(c) an audio speaker that is supported by the structure of the accessory;
(d) a microphone that is supported by the structure of the accessory;
(e) a camera that is supported by the structure of the accessory;
(f) an electronic circuit for conducting when the accessory and the smartphone are in circuit communication with one another
(i) between the smartphone and the touch screen of the accessory signals intended for conduction to and from a touch screen of the smartphone,
(ii) from the smartphone to the audio speaker of the accessory signals intended for conduction to the audio speaker of the smartphone;
(iii) from the accessory to the smartphone signals from the microphone and camera;
and (g) a means for mating the electronic circuit of the accessory in circuit communication to an electronic circuit of the smartphone.

15. The accessory for a smartphone of claim 14 further comprising a power source for at least the touch screen.

16. The accessory for a smartphone of claim 14 wherein the means for mating the electronic circuit of the accessory to the electronic circuit of the smartphone includes a cable with a member for mating that mates with a complementary component of the cell phone, the cable being in circuit communication with the electronic circuit of the accessory.

17. The accessory for a smartphone of claim 14 wherein the electronic circuit of the accessory is in circuit communication with an electronic circuit of a smartphone and the smartphone includes a component that recognizes when the electronic circuit of the accessory is in circuit communication with the electronic circuit of the smartphone and facilitates conduction of signals between the electronic circuit of the accessory and the electronic circuit of the smartphone.

18. The accessory for a smartphone of claim 14 wherein the electronic circuit of the accessory is mated to the electronic circuit of the smartphone via a port of the smartphone that communicates with an electronic circuit of the smartphone.

19. The accessory for a smartphone of claim 18 wherein the member for mating is a plug mated to the smartphone via a complementary port of the smartphone that communicates with the electronic circuit of the smartphone.

20. The accessory for a smartphone of claim 17 wherein the touch screen of the accessory has a viewable surface area that is larger than a viewable surface area of the touch screen of the smartphone.
